(19) United States
(12) Patent Application Publication
(10) Pub. No.: US 2010/0088957 A1
(43) Pub. Date: Apr. 15, 2010

(54) NATURAL TURF WITH BINDER

(76) Inventor: Jonathan W. Hubbs, Phoenix, AZ (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 12/248,851

(22) Filed: Oct. 9, 2008

(51) Int. Cl. A01G 1/00

(52) U.S. Cl. 47/1.1 R

(57) ABSTRACT

A playing surface according to the invention includes turf, sand, fibers and organic binder, wherein the playing surface may be harvested in rolls. A field including the playing surface may have a sand base layer.

### FIELD OF THE INVENTION

The invention relates to playing surfaces and to fields including playing surfaces. An example of a playing surface according to the invention includes turf, sand, fibers and organic binder, wherein the surface may be harvested in a roll. The surface may optionally include one or more of a polymeric binder, fertilizer, gypsum, wax, gel, clay, and oil.

### BACKGROUND OF THE INVENTION

As used herein and throughout, the following terms have the meanings described as follows:
a. The term “soil” refers to particulate surface material of the earth, whether or not it contains organic matter, and includes one or more of sand, silt, clay, and crushed rock such as decomposed granite.
b. The term “sand” refers to any granular material formed by the disintegration of rocks to form particles smaller than gravel but coarser than silt. Sand may or may not include organic matter.
c. The term “silt” refers to any unconsolidated sedimentary material with rock particles usually 1/20 millimeter or less in diameter, and being generally smaller than sand but coarser than clay. Silt may or may not include organic matter.
d. The term “clay” refers to any (1) inorganic earth surface material that is plastic when moist but hard when fired and that is comprised primarily of hydrous aluminum silicates and/or other minerals, or (2) substance having the properties of clay. Clay includes dry or wet materials and may or may not include organic matter.
e. The term “polymeric binder” or “polymeric soil binder” means a soil binder that binds together soil particles and that can be dispersed or dissolved into an oil.
f. The term “playing surface” means a surface that includes natural turf grown in sand, fibers and organic binder.
g. The term “sod” means natural turf grown in clay.
h. The term “composite field” means a surface having a playing surface according to the invention positioned on top.

In existing processes, turf is grown in clay to be harvested and placed on another surface, often an athletic field. Clay is used because it holds together when the turf and clay (i.e., sod) are harvested together. Clay is tacky with fine particles that bind together, so the sod (including grass, grass roots and clay) can be rolled, transported to the field where it is to be used and then rolled out onto the field. There are some problems with this methodology. First, clay is heavy, thus making transportation and movement of the rolled sod difficult. Second, clay, especially when compacted, does not permit water to easily pass through and water can collect on the surface of the sod once the sod is placed on a field. Also, when the sod is removed from the surface of the field, some clay from the sod usually remains on the base layer of the surface (which is typically sand to allow for drainage), and the clay must be removed so (1) the sand can be leveled without clumps of clay being present, and (2) it does not create drainage problems.

It is also known to grow turf in sand in square or rectangular plastic/trays using fibers to bind the sand and roots. The square or rectangular sections of turf produced by this process must be removed from the trays and applied to a surface one at a time, and are thus labor intensive to use.

### SUMMARY OF THE INVENTION

The invention relates to playing surfaces and methods for producing playing surfaces. A playing surface according to an embodiment of the invention includes turf (i.e., grass and grass roots), sand, fibers and an organic binder, wherein the playing surface can be harvested in a roll, either by simply rolling it up like a rug (as most sod is rolled), or rolling it around a mandrel or other cylindrical structure. The playing surface may optionally include one or more of: a polymeric binder, fertilizer, gypsum, wax, gel, clay and oil. The present invention allows a playing surface to be grown, harvested and deployed in long rolls utilizing sand, instead of clay. This renders the resulting playing surface lighter and easier to transport and use, and it has much better drainage than sod, which includes clay. Further, clumps of clay are not left behind when the playing surface is removed from the surface to which it is applied.

Another aspect of the present invention relates to providing a composite field including a base layer designed for drainage and a playing field on top of the base layer. The base layer is typically sand between 6″ and 12″ in depth. The base layer may have a conditioned top layer on which the playing surface is positioned.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a flowchart representing a method of providing a playing surface in accordance with the present invention.

FIG. 2 is a flowchart representing a method of applying a playing surface in accordance with the present invention.

### DETAILED DESCRIPTION OF PREFERRED EMBODIMENTS OF INVENTION

The present invention relates to a playing surface with turf, sand, fibers and organic binder that can be harvested, transported and deployed in rolls. These rolls can be delivered to a desired location for application, and are preferably applied to a surface having a sand base layer on which the playing surface is placed. The playing surface can also include one or more of a polymeric binder, fertilizer, gypsum, wax, gel, clay, and oil. The various components are described below.

### Turf

The turf can be any suitable grass that can be utilized with the invention.

### Fibers

A playing surface according to the invention includes one or more fibers and, as used herein, “fibers” refers to one or more fibers. The fibers can be any fibers, ribbons or strips of material used to add mechanical strength to the sand and/or soil. The fibers include inorganic fibers and/or plastic strips. The plastic strips can be polypropylene. The fibers may be any suitable length for adding mechanical strength to the sand and/or soil. Preferably, the fibers are between ½ and 2 inches long. The fibers may be any shape or various shapes suitable for providing mechanical strength to the sand and/or soil.

The preferred fiber is Stalok® plastic strip fibers supplied by Stabilizer Solutions, Inc. of Phoenix, Ariz. and having the following properties:

Stalok ® Product Specifications

| Property | Test Method | Requirement |
|---|---|---|
| Polypropylene | ASTM D4101 | 99% Minimum |
| | Group 1/Class 1/Grade 2 | |
| Moisture Absorption | • | Nil |
| Fiber Length | Measured | ½ to 2 inch, minimum |
| Color | • | Green, Manila, Black |
| Specific Gravity | ASTM D792 | 0.91 gm/cm3 |
| Tensile Strength | ASTM D2256 | 40,000 psi, minimum |
| Tensile Elongation | ASTM 2256 | 20%, maximum |
| Young's Modulus | ASTM D2101 | 600,000 psi, minimum |

Depending on the inherent mechanical strength of the soil, a percentage by weight of fibers can be added to the soil based on the desired mechanical strength. Generally, this amount is based on the amount of fibers needed to hold the playing surface together during its intended use. For instance, in one embodiment, the playing surface includes approximately 4-20 pounds of fibers per one ton of soil.

### Gypsum

Gypsum improves soil and/or sand structure with regard to moisture dispersal. Gypsum can also assist in dispersal of nutrients that use liquid delivery systems. In one embodiment, this allows for better distribution of nutrients, facilitates roots to grow, aids moisture to reach the organic binder, and increases drainage of liquid. If used, the amount of gypsum is preferably between 10-50 pounds per one ton of soil, with 25 pounds of gypsum per one ton of soil being most preferred.

### Soil

Soil according to the invention includes sand, the definition of which in this invention includes decomposed granite, and may or may not include organic matter. Virtually any decomposed granite (also referred to as “D.G.”) having sand particles may be used, including ¼″ D.G. or D.G. finely screened to 2 mil size. The soil according to this invention is at least 80% by weight sand.

### Organic Binder

A playing surface according to the invention can include one or more organic binders and, as used herein, “an organic binder” refers to one or more organic binders. The organic binder is any organic, granular (or particulate) material that can be mixed with soil when dry, and that exudes, or turns into, a tacky substance when wet that binds the soil particles together. The organic binder is preferably dried and ground plantago (also known as “psyllium”). If dried and ground plantago is used, it preferably includes plantago seed husk and most preferably 80% or more, or 90% or more, plantago seed husk. Other binders, either organic or inorganic, may be utilized. The amount and type of binder included is chosen, to provide the desired properties of the resulting playing surface. Preferably, organic binder is mixed with the sand at a weight ratio of about 4-20 pounds, and most preferably 8-15 pounds of organic binder per ton of soil. Alternatively, dried and ground plantago coated or mixed with wax and/or polymer may be used.

### Oil

As used herein, “an oil” refers to one or more oils. Among the suitable petroleum oils are those containing low or no aromatic fractions, and that are generally fluid at temperatures between 30° and 120°. Examples of oils suitable for use in the present invention include paraffinic oils and low-aromatic naphthenic oils. A commercially available example of a paraffinic oil includes Exxon's 150 SE solvent extracted bright stock FN-2507, and of a low-aromatic naphthenic oil includes Cyclolube No. 2290 available from Witco. Additionally, soy oil, cotton seed oil, or mineral oil may be used and HT-100 mineral oil from IGI is most preferred. The oil could also be an aqueous-based solution.

### Polymeric Binder

A polymeric binder according to the invention is any substance that may be dissolved or dispersed in the oil and that provides cohesion between soil and/or sand particles (i.e., it binds soil and/or sand particles). The polymeric binder helps to seal the outer surface of the finished surface material, because of the particle adhesion it provides, and because it preferably is water resistant. Polymeric binder and oil combined could be used in place of the organic binder to bind the sand particles.

Polymeric binders suitable for use in the present invention include interpolymers of butene, ethylene, and/or propylene with ethylenically unsaturated monomers, including vinyl acetate, methyl acrylate, ethyl acrylate and the like. Other polymeric binders suitable for use in the present invention include amorphous polymers that are soluble or dispersable in an oil according to the invention. Commercially available examples of suitable poly alpha-olefin interpolymers include Vestoplast 608 or 708 from Huls. The most preferred polymeric binder is VESTOPLAST® SI, and is supplied by CREANOVA Inc., Turner Place, Box 365, Piscataway, N.J. 08855. Its Environmental & Regulatory Affairs, Information Number is 908-981-5016.

### Gel

A gel according to the invention can be used in place of oil, or in addition to the oil, or in place of the oil and polymeric binder, depending upon the viscosity of the gel, its ability to bind soil and/or sand particulates, its ability to make the resulting surface water resistant, and whether, when mixed with a carrier, the resulting mixture can be added to soil and/or sand as a granular material.

A preferred gel is Petox 310, which has the consistency of soft petroleum jelly.

### Wax

Among the waxes that may be used to practice the invention is IGI 422. IGI 422 is a microcrystalline-based slack wax. It has the tackiness and flexibility that are common with some grades of microcrystalline waxes. It is recommended for use as a coating or for impregnating for waterproofing, sweeping compounds, metal protection, lubricating, polishing, tanning, and has the following physical properties:

| | ASTM | SPECIFICATIONS | | |
|---|---|---|---|---|
| TEST METHOD | METHOD | Minimum | Maximum | TYPICAL |
| Drop Melt Point ° F. | D 127 | — | — | 166 (74.4) |
| (° C.) | | | | |
| Congealing Point ° F. | D 938 | 153 (67.2) | 167 (75) | 160 (71.1) |
| (° C.) | | | | |
| Kinematic Viscosity, | D 445 | 16.0 | 23.0 | 19.5 |
| cSt @ 210° F. (98.9° C.) | | | | |
| Saybolt Viscosity, | D 2161 | 81.9 | 111.4 | 96.4 |
| SUS @ 210° F. | | | | |
| (98.9° C.) | | | | |
| Solvent Extractables*, | D 3235* | — | — | 20.0 |
| Wt % | | | | |
| Flash Point (P.M.), ° F. | D 93 | 464 (240) | — | 504 (262) |
| (° C.) | | | | |
| Color | D 1500 | — | — | 3.0 |

*Modified test method. 1 g sample/30 mls solvent (60% MEK, 40% Toluene)
FDA STATUS: IGI 422 is not intended for food contact.

IGI 1266U is another wax that may be used to practice the invention. IGI 1266U is a relatively high melting, refined paraffin wax and may be used for applications which do not require a wax meeting FDA specifications. IGI 1266U has the following physical properties:

PHYSICAL PROPERTIES

| | ASTM | SPECIFICATIONS | | |
|---|---|---|---|---|
| TEST METHOD | METHOD | Minimum | Maximum | TYPICAL |
| Congealing Point ° F. | D 938 | 154 (67.8) | 160 (71.1) | 157 (69.4) |
| (° C.) | | | | |
| Kinematic Viscosity, | D 445 | 6.7 | 7.8 | 7.3 |
| cSt @ 210° F. (98.9° C.) | | | | |
| Saybolt Viscosity, | D 2161 | 48.1 | 51.8 | 50.1 |
| SUS @ 210° F. | | | | |
| (98.9° C.) | | | | |
| Oil Content, Wt % | D 721 | — | 1.0 | — |
| Color | D 1500 | — | — | L1.0 |
| | | | | (Off- |
| | | | | white/tan) |
| Odor | D 1833 | — | — | 2 |
| Needle Penetration, | D 1321 | — | — | 12 |
| dmm @ 77° F. (25° C.) | | | | |

FDA STATUS: IGI 1266U is not intended for food contact.

Each of the above-described waxes are sold by The International Group, Inc. (“IGI”), with locations at: 85 Old Eagle School Road, P.O. Box 384, Wayne, Pa. 19087 and 50 Salome Drive, Agincourt, Ontario, CANADA M2S 2A8.

The purpose of the wax is to help make the playing surface malleable and to add more cohesiveness between the soil and/or sand particles. Any wax capable of performing these functions may be used.

Additionally, either of the above-identified waxes (or any wax suitable for practicing the invention) may be provided in an emulsion such as an emulsion with water, the procedure for making such an emulsion being known to persons skilled in the art of emulsifying materials such as wax. The emulsion can then be stored and/or shipped in any suitable containers, such as cans, tanks, or drums. The emulsion can be added to a mixture of soil and/or sand and soil conditioner according to the invention in any fashion, such as by pouring or spraying it onto the mixture.

If used, the amount of polymeric binder, gel, oil and/or wax may be selected by simple trial and error based upon the desired characteristics of the playing surface.

### Playing Surface

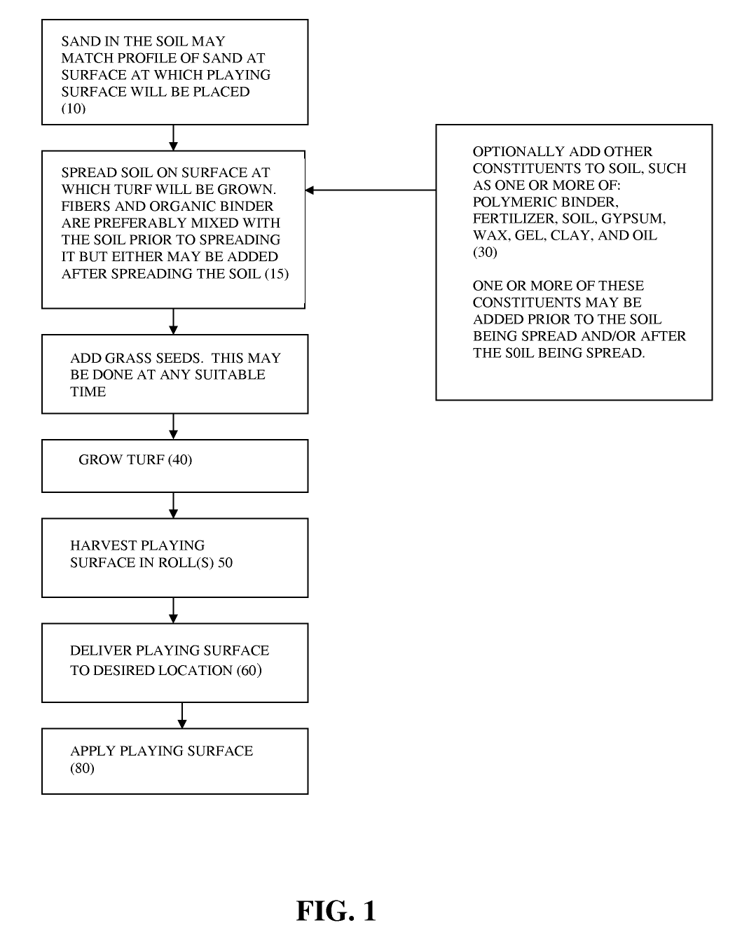

FIG. 1 is a flowchart representing a method and system of providing a composite field with a playing surface in accordance with the present invention.

First, the playing surface is created by growing turf in soil that includes at least 80% sand, fibers, organic binder and optionally one or more of oil, gel, polymeric binder, wax, gypsum and fertilizer. The type of sand in the soil used in the playing surface may be selected to substantially match the type of sand comprising the base layer of the surface at which the playing surface is to be deployed (10).

Preferably, the soil, fibers and organic binder (and, optionally, other constituents) are premixed and then spread on a surface (the surface typically has a drainage system underneath) at which the turf will be grown (15). Alternatively, the soil may be spread onto the surface first and the fibers, organic binder and (optionally) other constituents may be added, such as by tilling them into the soil. Alternatively, some constituents may be pre-mixed into the soil and others can be added after the soil is spread onto a surface. The playing surface soil (with fibers, organic binder and, optionally, other constituents) can be any desired depth. In one embodiment of the present invention, the soil for the playing surface has a depth of 2 inches to 6 inches over a growing area (15).

The turf is grown using any suitable method known to those skilled in the art, such as by adding grass seeds and allowing them to grow into grass under suitable conditions. Any suitable seed for producing turf may be used and can be added in any suitable manner for growing and harvesting one or more rolls of playing surface according to the invention.

Any desired mixing technique for mixing the soil, fibers, organic binder, and/or other constituents may be used. For example, the fibers, organic binder and/or other constituents may be mixed into the soil after the soil is spread on the ground. Mixing may be performed manually, such as with a rake, or in any mechanized fashion. Alternatively, one or more of the fibers, organic binder and/or other constituents may be premixed with the soil using any suitable technique, such as by being mixed in a concrete mixer. Turf seeds are normally added after the sand has been mixed with other constituents and spread out in a layer. When harvested, the grass is preferably between ¾″ and 2″ in length, and most preferably about 1″ in length.

The grass can be ¾″-2,″ and most preferably, 1″ in length. In one embodiment of the present invention, the thickness of the playing surface is between 2″ and 8″ thick (including the grass at about 1″ in length) and most preferably between about 3″ and 6″ thick.

In step 50, the playing surface can be harvested using any suitable equipment. Preferably, the playing surface is harvested in a width of between 2 feet and 8 feet, in lengths of between 10 and 40 feet. These harvested playing surface sections may be rolled and delivered to a desired relocation area (60). These harvested rolls are lighter than, and do not display the hardening or water pooling characteristics presented by, turf with clay.

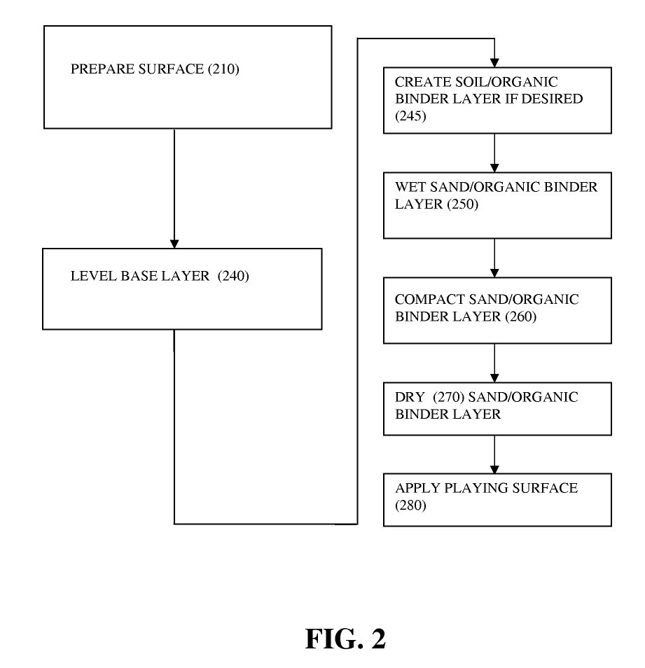

FIG. 2 depicts an exemplary method of providing a composite field, such as an athletic field, in accordance with the present invention. In this exemplary method, the surface at the desired relocation area is prepared (210), if necessary. This may include removal of an existing playing surface, or as in the case of a new application, applying an appropriate base layer. The type of sand in the base layer may substantially match the type of the sand of the soil of the playing surface.

In one embodiment of the present invention, a base layer of sand is located on the surface, and the playing surface is placed on the base layer. The base layer may also comprise an organic binder, such as psyllium, that is spread on top of the sand, then wetted and tamped prior to placement of the turf (245, 250, 260, 270). This provides a solid, stable surface for the playing surface, and helps retain a desired grade (such as flat) for the playing surface. Other constituents, such as gypsum, may be added to the base layer to improve drainage.

The playing surface can be applied at the desired prepared location (280) in any manner, such methods of applying playing surfaces being known to those skilled in the art. Preferably, the harvested rolls of playing surface are unrolled into position on the base layer.

The invention may be used for virtually any surface application, especially athletic fields such as, football fields, baseball fields, soccer fields, tennis courts, horse training arenas, exercising, horse jumping and racing surfaces, golf courses, or other applications, including lawns.

Having now described preferred embodiments of the invention variations that do not depart from the spirit thereof will become apparent to others. The invention is thus not limited to the preferred embodiments but is instead set forth in the following claims and legal equivalents thereof. Unless stated otherwise in the claims, method steps may be performed in any order capable of providing a result according to the invention.

What is claimed is:

1. A playing field comprising: turf, a soil comprising at least 80% sand, fibers and organic binder.

2. The playing field of claim 1 that is harvested in a roll, and wherein the roll is between 3 feet and 8 feet wide and between 10 feet and 40 feet in length, and the playing surface has turf on one side and at least some sand on the opposite side.

3. The playing field of claim 1 that further comprises one or more of the group consisting of: polymeric binder, fertilizer, gypsum, wax, gel, clay, and oil.

4. The playing field of claim 1 that includes between 4 and 20 pounds of fibers per one ton of soil.

5. The playing field of claim 1 that includes soil other than sand.

6. The playing field of claim 1 wherein the roll is wrapped around a mandrel or other cylindrical object.

7. The playing field of claim 1 wherein the organic binder includes dried and ground plantago seed husk.

8. The playing field of claim 6 wherein the organic binder comprises 90% or more dried and ground plantago husk.

9. The playing field of claim 1 that includes 8-15 pounds of organic binder per one ton of soil.

10. The playing surface of claim 1 that includes 4-20 pounds of organic binder per one ton of soil.

11. The playing surface of claim 1 wherein the fibers include inorganic fibers.

12. The playing surface of claim 1 wherein the fibers are plastic strips.

13. The playing surface of claim 12 wherein the plastic strips are comprised of polypropylene.

14. The playing surface of claim 1 wherein the fibers are between ½″ and 2″ long.

15. The playing surface of claim 1 that is at least 3½″ thick.

16. The playing surface of claim 1 that is at least 4″ thick.

17. The playing surface of claim 1 wherein the roll is at least 25 feet long.

18. The playing surface of claim 1 wherein the roll is at least 30 feet long.

19. The playing surface of claim 1 wherein the roll is at least 40 feet long.

20. The playing surface of claim 1 wherein the roll is at least 4 feet wide.

21. The playing surface of claim 1 wherein the roll is at least 5 feet wide.

22. The playing surface of claim 1 wherein the roll is at least 6 feet wide.

23. The playing surface of claim 1 wherein the roll is at least 8 feet wide.

24. A composite surface including the playing surface of claim 1 positioned on a base layer comprised of sand.

25. The composite surface of claim 24 wherein the base layer is between 6″ and 12″ deep.

26. The composite surface of claim 24 wherein the base layer is water permeable.

27. The composite surface of claim 24 wherein the base layer includes an upper surface that comprises a mixture of sand and organic binder.

28. The composite surface of claim 27 wherein the upper surface includes between 2-10 lbs. of organic binder per ton of sand.

29. The composite surface of claim 27 wherein the upper surface is between 2″ and 4″ deep.

30. The composite surface of claim 27 wherein the upper surface was wetted and tamped to form a hard surface.
